(19) United States
(12) Patent Application Publication
(10) Pub. No.: US 2019/0043200 A1
(43) Pub. Date: Feb. 7, 2019

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Takayuki Hara, Kawasaki-shi (JP)

(21) Appl. No.: 16/051,800

(22) Filed: Aug. 1, 2018

(30) Foreign Application Priority Data
Aug. 4, 2017 (JP) 2017-151759

(51) Int. Cl. G06T 7/11; G02B 27/00; G06T 5/00

(52) U.S. Cl. CPC G06T 7/11; G06T 5/002; G02B 27/0037

(57) ABSTRACT

An image processing apparatus has a first memory for storing an input image, a second memory for storing an image of a rectangular region read out from the first memory, and an image processing unit for generating an image. At a first position in an image after geometric deformation, a third rectangular region that encompasses a region of the image before geometric deformation that corresponds to a first rectangular region from among a plurality of first rectangular regions obtained by dividing the image after geometric deformation is read out, and at a second position of the image after geometric deformation, a fourth rectangular region that encompasses regions of the image before geometric deformation that correspond to a plurality of second rectangular regions obtains by further dividing the first rectangular regions is read out.

### BACKGROUND OF THE INVENTION

### Field of the Invention

The present invention relates to a technique for reducing the capacity of a work memory in the case where an image is divided into small regions, and geometric deformation processing is performed for each of the divided regions.

### Description of the Related Art

In recent years, an increasing number of digital still cameras, digital video cameras, and the like have functions of correction of distortion aberration of a lens, electronic image stabilization, correction of rolling shutter distortion due to an image sensor, and the like. In order to realize such functions, it is necessary to apply various types of geometric deformation processing to an image.

As a method for realizing geometric deformation processing at a high speed, a technique for copying a rectangular small region from image data in a DRAM to an SRAM or the like, and performing geometric deformation processing is disclosed in Japanese Patent Laid-Open No. 2016-100717. A DRAM is a memory that allows higher-speed sequential access than random access, and an SRAM is a memory that allows high speed random access. Therefore, geometric deformation processing can be performed at a high speed by performing random access to copied rectangular regions at a high speed in an SRAM, and performing geometric deformation.

On the other hand, the cost of a work memory such as an SRAM is high, and a work memory having a capacity that can store an entire input image that is desired to be processed is difficult to provide in a digital camera and the like in consideration of the cost. Therefore, as disclosed in Japanese Patent Laid-Open No. 2016-100717, it is realistic to divide an output image into small regions, and provide a work memory having a capacity that can store each small region.

However, a work memory that is provided in a digital camera or the like has a fixed capacity, and even if the sizes of small regions of an output image after geometric deformation are the same, the sizes of small regions that are each copied from an input image before geometric deformation to a work memory are different according to the content of geometric deformation and coordinate positions.

For example, in the case of correcting pincushion distortion aberration through geometric deformation, reduction is included in the correction with respect to regions corresponding to the four corners of an input image, and thus regions larger than small regions of an output image are required to be imported to a work memory. Also, in the case of performing tilt correction, reduction may be included in the correction with respect to a portion of an input image, and, regarding this portion, a region larger than the small region of an output image need to be imported to a work memory.

As a countermeasure in the case where the usage of a work memory differs for each of a large number of small regions of an output image in this manner, it is conceivable that a work memory having a large capacity is provided in accordance with a small region corresponding to the worst condition under which the usage of the work memory is largest. However, in this case, the efficiency of image processing is high, but the capacity of an expensive work memory becomes excessive for a large number of small regions which do not correspond to the worst condition, which is wasteful, and brings about an increase in cost of the apparatus.

In addition, as another method, it is conceivable that all of the small regions of an output image are set to be small such that even a small region that corresponds to the worst condition fits in the capacity of a work memory that is provided in advance. However, a memory such as a DRAM that holds an input image is specialized in sequential access, and thus it is efficient to perform readout that is as continuous as possible. Therefore, if the sizes of small regions are reduced, there is a problem in that access to a small region frequently occurs, and the efficiency decreases. Furthermore, geometric deformation is accompanied by pixel interpolation such as bi-cubic interpolation, and thus not only pixels at a reference coordinate position but also nearby pixels required for the interpolation need to be imported to a work memory. Therefore, if the sizes of small regions of an output image are reduced and the number of small regions is increased, the number of pixels of the overlapping regions in the boundary portions between those small regions increases, and thus the readout amount increases. In addition, there is also a problem in that an access band for an input image memory such as a DRAM is occupied. Therefore, to set small regions to be small is favorable for suppressing the cost of the apparatus, but tends to decrease the efficiency of image processing.

Conventionally, as described above, realizing both suppression of an increase in cost of an apparatus and an improvement of the efficiency in geometric deformation processing has been a difficult problem.

### SUMMARY OF THE INVENTION

The present invention has been made in light of the above-described problems, and provides an image processing apparatus that can achieve both suppression of an increase in the cost of an apparatus and an improvement in the efficiency of geometric deformation processing in the case of dividing an image into small regions and performing geometric deformation processing.

According to a first aspect of the present invention, there is provided an image processing apparatus that applies geometric deformation to an input image, comprising: at least one non-transitory memory device; at least one processor; a first memory configured to store the input image as an image before geometric deformation; a calculation unit configured to calculate coordinates of a region of the image before geometric deformation that corresponds to a region included in the image after geometric deformation; a readout unit configured to read out, from the first memory, a rectangular region that encompasses the region of the image before geometric deformation calculated by the calculation unit; a second memory configured to store the rectangular region read out by the readout unit; and an image processing unit configured to read out the image before geometric deformation from the second memory, and generate the image after geometric deformation, wherein, at a first position of the image after geometric deformation, the readout unit reads out a third rectangular region that encompasses a region of the image before geometric deformation that corresponds to a first rectangular region corresponding to the first position from among a plurality of first rectangular regions obtained by dividing the image after geometric deformation, based on coordinates of the region of the image before geometric deformation that corresponds to the first rectangular region, and, at a second position of the image after geometric deformation, reads out a fourth rectangular region that encompasses a region of the image before geometric deformation that corresponds to a second rectangular region corresponding to the second position from among a plurality of second rectangular regions obtained by dividing the first rectangular regions, based on coordinates of the region of the image before geometric deformation that corresponds to the second rectangular region, and wherein the calculation unit, the readout unit, and the image processing unit are implemented by the at least one processor executing at least one program recorded on the at least one non-transitory memory device.

According to a second aspect of the present invention, there is provided an image processing method for applying geometric deformation to an input image, the method comprising: storing the input image as an image before geometric deformation to a first memory; calculating coordinates of a region of the image before geometric deformation that corresponds to a region included in the image after geometric deformation; reading out, from the first memory, a rectangular region that encompasses the region of the image before geometric deformation calculated in the calculation; storing the rectangular region read out in the reading out, to a second memory; and reading out the image before geometric deformation from the second memory and generating the image after geometric deformation, wherein, in the reading out, at a first position of the image after geometric deformation, a third rectangular region that encompasses a region of the image before geometric deformation that corresponds to a first rectangular region corresponding to the first position from among a plurality of first rectangular regions obtained by dividing the image after geometric deformation is read out based on coordinates of the region of the image before geometric deformation that corresponds to the first rectangular region, and, at a second position of the image after geometric deformation, a fourth rectangular region that encompasses a region of the image before geometric deformation that corresponds to a second rectangular region corresponding to the second position from among a plurality of second rectangular regions obtained by dividing the first rectangular regions is read out based on coordinates of the region of the image before geometric deformation that corresponds to the second rectangular region.

Further features of the present invention will become apparent from the following description of exemplary embodiments with reference to the attached drawings.

### BRIEF DESCRIPTION OF THE DRAWINGS

FIG. 1 is a block diagram showing the configuration of an image processing apparatus according to a first embodiment of the present invention.

FIG. 2 is a diagram showing divided rectangular regions of an image after deformation.

FIGS. 3A and 3B are diagrams showing generation of coordinates in rectangular regions of an image after deformation.

FIGS. 4A and 4B are diagrams showing the correspondence relationship between rectangular regions of an image after deformation and a region of the image before deformation.

FIGS. 5A to 5D are diagrams showing coordinates on an image before deformation that correspond to rectangular regions.

FIG. 6 is a block diagram showing the configuration of an image processing apparatus according to a second embodiment.

FIGS. 7A and 7B are diagrams showing generation of coordinates in rectangular regions of an image after deformation.

FIGS. 8A to 8F are diagrams showing coordinates on an image before deformation that correspond to rectangular regions.

FIGS. 9A to 9C are image diagrams of rearrangement of output that is made by a rectangle size conversion circuit.

### DESCRIPTION OF THE EMBODIMENTS

Embodiments of the present invention will be described below in detail with reference to the attached drawings. Note that, in the embodiments, a case will be described in which the present invention is applied to an image processing apparatus provided in a digital camera. However, the present invention can also be applied to an image capturing apparatus such as a digital video camera, a mobile phone with camera, or a vehicle camera, or an image processing apparatus that requires geometric deformation such as a projector.

### First Embodiment

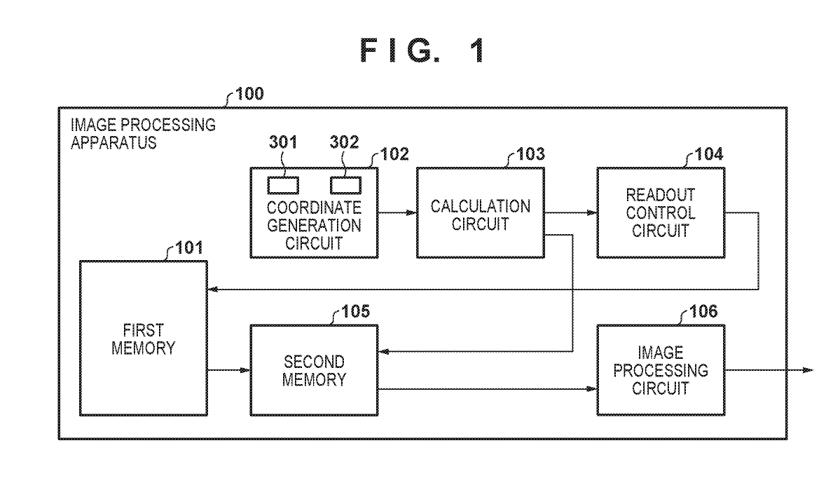

FIG. 1 is a block diagram showing the configuration of an image processing apparatus according to a first embodiment of the present invention.

In FIG. 1, an image processing apparatus 100 is an apparatus that applies geometric deformation processing to input image data that has been input, and includes a first memory 101, a coordinate generation circuit 102, a calculation circuit 103, a readout control circuit 104, a second memory 105, and an image processing circuit 106.

The first memory 101 stores input image data that has been input, as an image before deformation (geometric deformation). The coordinate generation circuit 102 generates coordinate of rectangular regions of an image to which deformation (geometric deformation) processing has been applied. Also, the coordinate generation circuit 102 has a contour coordinate generation circuit 301 and an output coordinate generation circuit 302, which will be described later. The calculation circuit 103 calculates coordinates of an image before deformation that correspond to the coordinates of the rectangular regions of the image after deformation generated by the coordinate generation circuit 102. The readout control circuit 104 reads out the image before deformation, from the first memory 101 for each rectangular region based on the coordinates of some of the rectangular regions in the image before deformation that have been calculated by the calculation circuit 103. The second memory 105 temporarily stores the image before deformation that has been read out by the readout control circuit 104, for each rectangular region. The image processing circuit 106 reads out the image before deformation from the second memory 105 based on the coordinates in a rectangular region in the image before deformation that have been calculated by the calculation circuit 103, applies geometric deformation processing, and generates the image after deformation.

Specifically, the first memory 101 uses a relatively inexpensive memory such as a DRAM that allows higher-speed sequential access than random access. This memory has a capacity that can store entire input image data that is to be subjected to at least geometric deformation processing. The entire input image data refers to data having a size for containing the range of an angle of view of geometric deformation that is processed at a time.

In addition, a memory such as an SRAM that allows high-speed random access is used as the second memory 105. The SRAM is advantageous for achieving high-speed image processing, but is expensive compared to a DRAM, and thus, in this embodiment, the second memory 105 has a capacity to an extent that allows one of the rectangular regions of a deformed image to be fitted therein. This can be described as a capacity that allows a region (corresponding to an image central portion) in an image before deformation to be fitted in, the region corresponding to one of the rectangular regions in the image after deformation, and being smallest, in the case of performing processing for correcting distortion aberration of a taking lens as geometric deformation of the image, as will be described later. Note that, in this case, in a peripheral portion of the image, the size of the region in the image before deformation that corresponds to one of the rectangular regions in the image after deformation is larger than that in the image central portion.

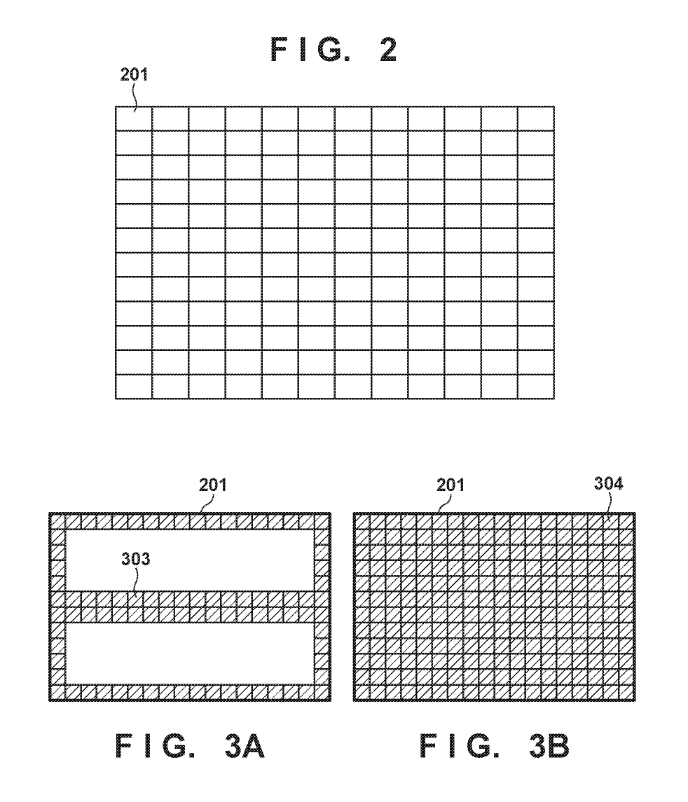

As shown in FIG. 2, the coordinate generation circuit 102 divides an image after deformation into rectangular regions 201 that are a plurality of small regions. The coordinate generation circuit 102 has the contour coordinate generation circuit 301 that scans the contours of the rectangular regions 201 and the output coordinate generation circuit 302 that entirely scans the rectangular regions 201.

As shown in FIG. 3A, the contour coordinate generation circuit 301 sequentially generates coordinates of the upper, left, right, and lower edges of each of divided rectangular regions acquired by vertically dividing the rectangular region 201 on an image after deformation into two (the coordinates at which pixels 303 indicated by diagonal lines in FIG. 3A are positioned). In addition, the output coordinate generation circuit 302 sequentially generates coordinates so as to cover all of the pixels in the rectangular region 201 on the deformed image (coordinates at which pixels 304 indicated by diagonal lines in FIG. 3B are positioned).

The calculation circuit 103 performs coordinate conversion calculation for converting the coordinates on the image after deformation generated by the coordinate generation circuit 102, into coordinates on the image before deformation. For example, in the case of geometric deformation processing in which an image is rotated, calculation for multiplying the coordinate values by a rotation matrix is carried out. In addition, in the case of distortion aberration correction, coordinate calculation is performed by obtaining an image height, and adding a correction amount that is based on the image height. A specific calculation content of coordinate conversion is not related to the spirit of the present invention, and thus a detailed description thereof is omitted. Note that, for ease of understanding, an example will be described below in which processing for correcting distortion aberration of a taking lens is performed as geometric deformation of an image.

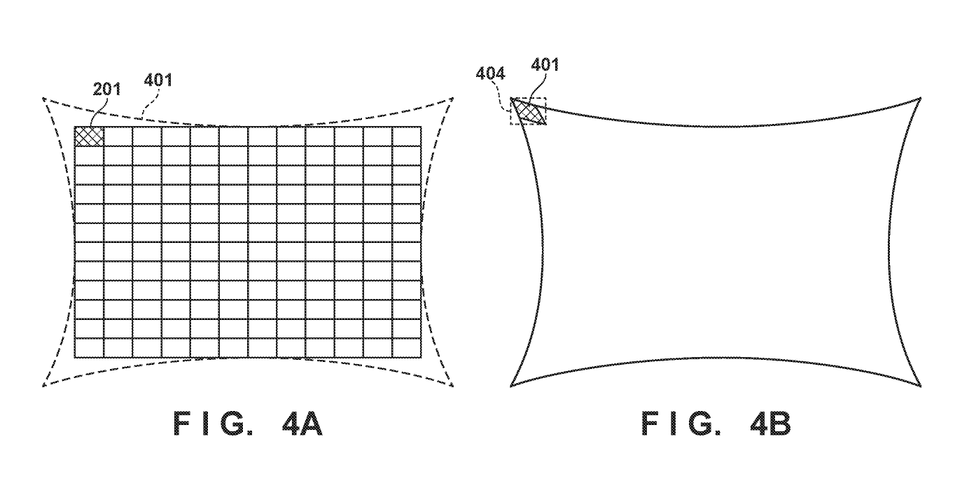

FIGS. 4A and 4B are diagrams showing the correspondence relationship between an image after deformation and the image before deformation. An image after deformation is divided into small rectangular regions 201 as described above in order to achieve a regular output order. The rectangular region 201 in FIG. 4A is one of the small rectangular regions. A region of the image before deformation that is required for generating the rectangular region 201 is a region 401 shown in FIG. 4B. The rectangular region 201 that forms an output image is generated by further reading a rectangular region 404 that encompasses this region 401 to the second memory 105, and performing geometric deformation processing. After that, by sequentially processing the regions of the image before deformation that correspond to the rectangular regions acquired by dividing the image after deformation similarly, the entire image after deformation is obtained.

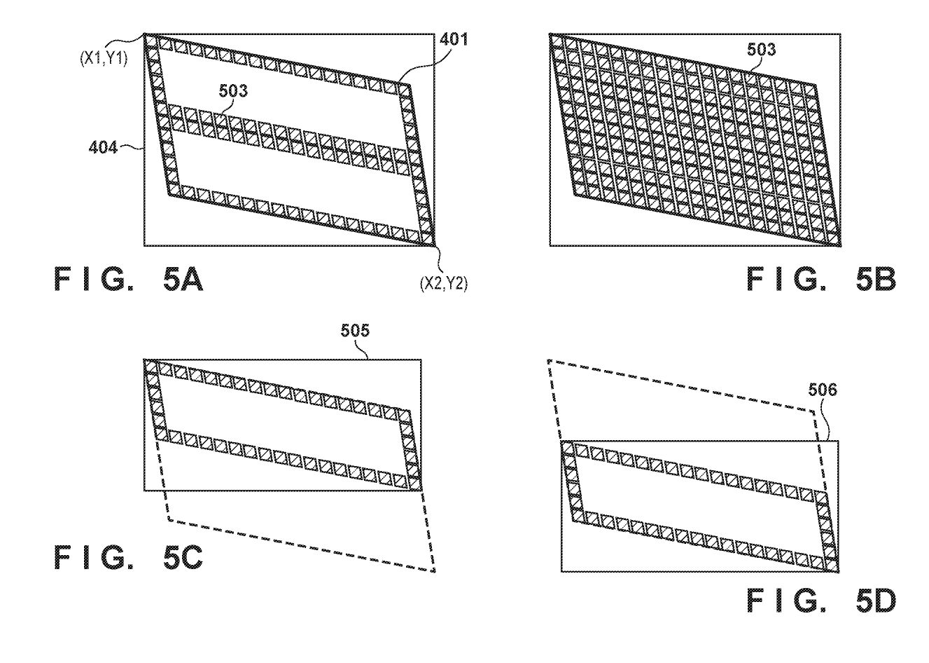

FIGS. 5A to 5D show images in which coordinates on an image after deformation generated by the coordinate generation circuit 102 are converted into coordinates on the image before deformation by the calculation circuit 103. The coordinates of the pixels 303 on the image after deformation generated by the contour coordinate generation circuit 301 in FIG. 3A are converted by the calculation circuit 103 to have a shape indicated by coordinates 503 in FIG. 5A. Note that the actual change in shape caused by deformation differs according to a calculation content of coordinate conversion, and thus this deformation is merely exemplary. The rectangular region 404 that encompasses the coordinate positions 503 of these contour coordinates on the image before deformation is obtained. Letting that the coordinate positions 503 of the contour coordinates on the image before deformation be (Px[n], Py[n]), the upper left coordinates (X1, Y1) and the lower right coordinates (X2, Y2) of the encompassing rectangular region 404 are obtained as follows, for example. Note that the origin of the coordinates is at the upper left of the image.

X1=min(Px[n]),Y1=min(Py[n])

X2=max(Px[n]),Y2=max(Py[n])

Also regarding the coordinate positions of contour coordinates on an image before deformation that correspond to the upper half/lower half of the image after deformation, similarly encompassing rectangular regions 505 and 506 are obtained (FIGS. 5C and 5D).

A usage capacity S of the second memory 105 required for performing geometric deformation on this encompassing rectangular region 404 and performing output is obtained as follows, for example.

S=(X2−X1+1)×(Y2−Y1+1)

Here, the capacity of the second memory 105 that is actually provided in the image processing apparatus 100 is indicated by Sth. If S≤Sth, the encompassing rectangular region 404 fits in the capacity of the second memory 105. Therefore, the encompassing rectangular region 404 is read out from the first memory 101, and is stored in the second memory 105. Subsequently, the image processing circuit 106 carries out geometric deformation processing based on the coordinates of an image before deformation that are obtained by the output coordinate generation circuit 302 and the calculation circuit 103. If S>Sth, the encompassing rectangular region 404 does not fit in the capacity of the second memory 105. Therefore, similar geometric deformation processing is carried out twice separately for the encompassing rectangular region 505 and the encompassing rectangular region 506.

The image processing circuit 106 reads out, from the second memory 105, the pixel values of the coordinates of the image before deformation calculated by the calculation circuit 103 that correspond to the coordinates of the converted image generated by the output coordinate generation circuit 302, and outputs the pixel values. Bilinear interpolation, bi-cubic interpolation, and the like may be carried out as necessary. Note that, in the case of performing such filtering, the encompassing rectangular regions 404, 505, and 506 need to be enlarged by the size of nearby pixels required for the filtering such that the nearby pixels are imported to the second memory 105.

As described above, in this embodiment, rectangular regions on an image after deformation are further divided according to the sizes of the regions on the image before deformation that correspond to the rectangular regions on the image after deformation so as to fit in a work memory. Accordingly, the sizes of all of the rectangular regions on the image after deformation do not need to be reduced in accordance with only a few worst cases.

In this embodiment, as an example, whether or not to perform further division is determined according to whether or not the sizes of regions of an image before deformation that correspond to rectangular regions of the image after deformation exceed the storing capacity of a second memory. However, as long as a configuration is adopted in which whether or not to perform further division is selected using the sizes of the regions of the image before deformation as a reference, another method may be used for the determination.

### Second Embodiment

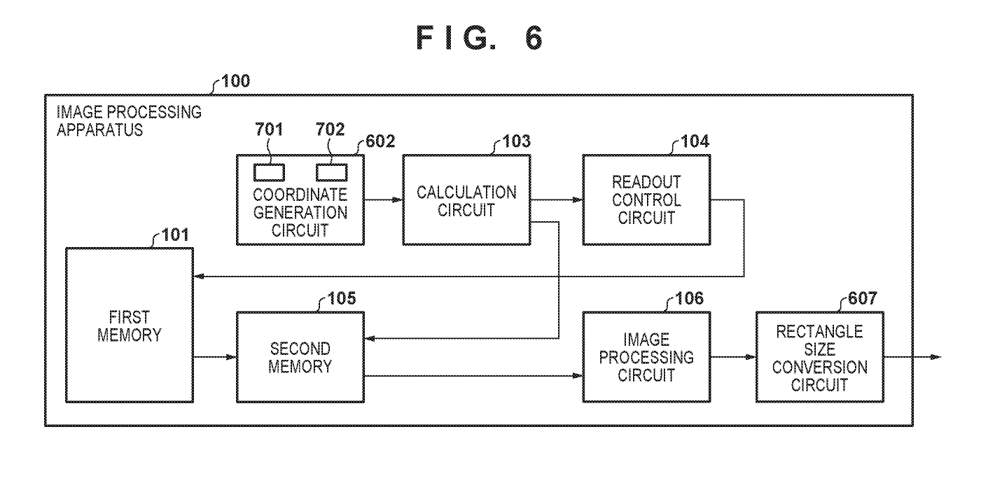

FIG. 6 is a block diagram showing the configuration of an image processing apparatus according to a second embodiment of the present invention.

In FIG. 6, an image processing apparatus 100 is an apparatus that applies geometric deformation processing to input image data that has been input, and has a first memory 101, a coordinate generation circuit 602, a calculation circuit 103, a readout control circuit 104, a second memory 105, an image processing circuit 106, and a rectangle size conversion circuit 607.

The first memory 101 stores input image data that has been input, as an image before deformation. The coordinate generation circuit 602 generates coordinates of rectangular regions of a deformed image to which geometric deformation processing has been applied. Also, the coordinate generation circuit 602 has a contour coordinate generation circuit 701 and an output coordinate generation circuit 702, which will be described later. The calculation circuit 103 calculates coordinates of an image before deformation that correspond to the coordinates of rectangular regions of the image after deformation generated by the coordinate generation circuit 102. The readout control circuit 104 reads out an image before deformation from the first memory 101 for each rectangular region based on the coordinates of some of rectangular regions in the image before deformation that have been calculated by the calculation circuit 103. The second memory 105 temporarily stores the image before deformation read out by the readout control circuit 104. for each rectangular region. The image processing circuit 106 read outs the image before deformation from the second memory 105 based on the coordinates of the rectangular regions in the image before deformation calculated by the calculation circuit 103, applies geometric deformation processing, and generates an image after deformation. The rectangle size conversion circuit 607 converts rectangular images of various sizes that are output from the image processing circuit 106, into images of a predetermined size.

In FIG. 6, the constituent elements are the same as those in the first embodiment except for the coordinate generation circuit 602 and the rectangle size conversion circuit 607, and thus a description of the same constituent elements is omitted, and only differences will be described.

The coordinate generation circuit 602 divides an image after deformation into rectangular regions 201 that are a plurality of small regions as shown in FIG. 2. The coordinate generation circuit 602 has the contour coordinate generation circuit 701 that scans the contours of the rectangular regions 201 and the output coordinate generation circuit 702 that entirely scans the rectangular regions 201.

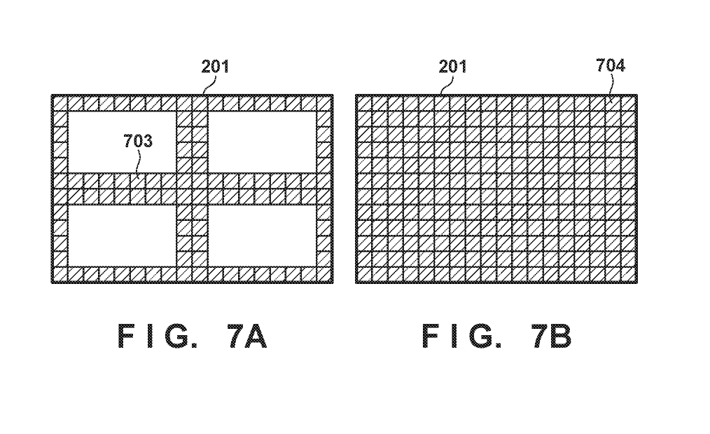

As shown in FIG. 7A, the contour coordinate generation circuit 701 sequentially generates the coordinates of the upper, left, right and lower edges of each of the upper left, upper right, lower left, and lower right divided rectangular regions acquired by (vertically and horizontally) dividing the rectangular region 201 on an image after deformation into four (the coordinates at which pixels 703 indicated by diagonal lines in FIG. 7A are positioned). In addition, the output coordinate generation circuit 702 sequentially generates coordinates so as to cover all of the pixels in the rectangular regions 201 on an image after deformation (the coordinates at which pixels 704 indicated by diagonal lines in FIG. 7B are positioned).

The calculation circuit 103 performs coordinate conversion calculation for converting coordinates on an image after deformation that have been generated by the coordinate generation circuit 602, into coordinates on the image before deformation.

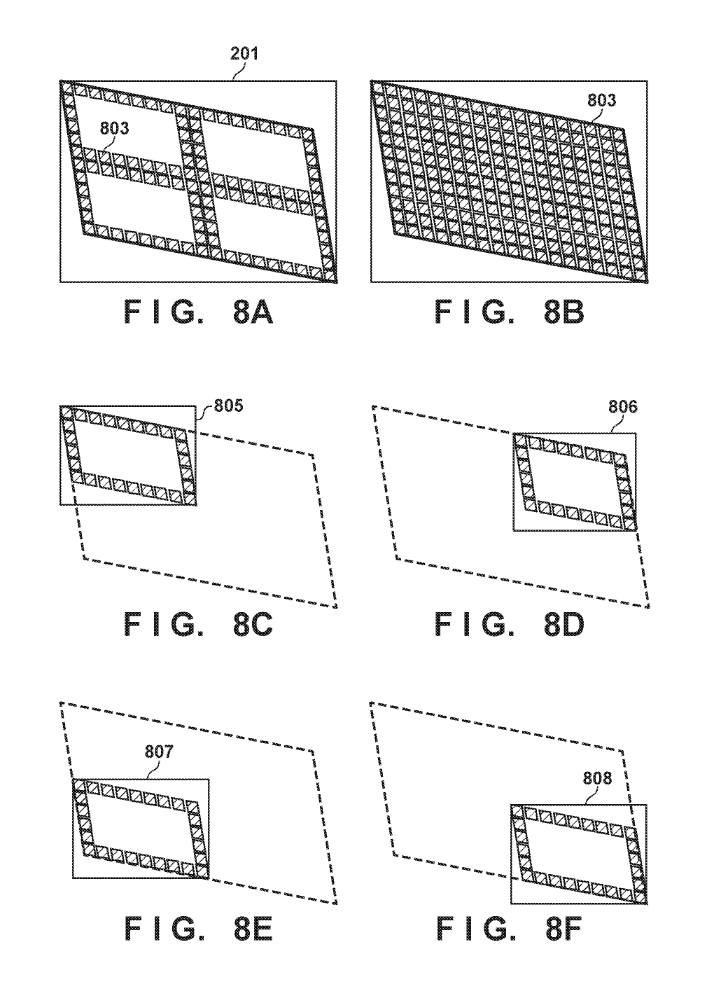

FIGS. 8A to 8F show an image in which the coordinates on an image after deformation generated by the coordinate generation circuit 602 are converted into coordinates on the image before deformation by the calculation circuit 103. The coordinates of the pixels 703 on the image after deformation generated by the contour coordinate generation circuit 701 in FIG. 7A are deformed into a shape indicated by coordinates 803 in FIG. 8A by the calculation circuit 103. Note that the actual change in shape caused by deformation differs according to a calculation content of coordinate conversion, and thus this deformation is merely exemplary. The rectangular region 201 that encompasses the coordinate positions 803 of these contour coordinates on the image before deformation is obtained. Letting that the coordinate positions 803 of the contour coordinates on the image before deformation be (Px[n], Py[n]), the upper left coordinates (X1, Y1) and the lower right coordinate (X2, Y2) of the rectangular region 201 that encompasses the coordinate positions 803 are obtained as follows, for example.

Note that the origin of the coordinates is at the upper left of the image.

X1=min(Px[n]),Y1=min(Py[n])

X2=max(Px[n]),Y2=max(Py[n])

Also regarding the coordinate positions of the contour coordinates on an image before deformation that correspond to upper left/upper right/lower left/lower right coordinates of the contour coordinates on the image after deformation, similarly encompassing rectangular regions 805, 806, 807, and 808 are obtained (FIGS. 8C, 8D, 8E, and 8F).

A usage capacity S1 of the second memory 105 required for performing geometric deformation on this encompassing rectangular region 201 and outputting the rectangular region 201 is obtained similar to the first embodiment. A usage capacity S2 of the second memory 105 required for performing geometric deformation on a rectangular region acquired by coupling two regions in combination of upper left and upper right regions or lower left and lower right regions and outputting the rectangular region after geometric deformation is also obtained. Furthermore, a usage capacity S3 of the second memory 105 required for performing geometric deformation on the encompassing rectangular regions 805, 806, 807, and 808 and outputting these rectangular regions after geometric deformation is also obtained. A combination for which the capacity of the second memory 105 is not exceeded and the usage capacity is largest is selected from these combinations. A rectangular region in the selected combination is read out from the first memory 101, and is stored in the second memory 105. The image processing circuit 106 then carries out geometric deformation processing based on the coordinates of the image before deformation that are obtained by the output coordinate generation circuit 702 and the calculation circuit 103. In addition, information regarding the selected combination of rectangular regions is output to the later-stage rectangle size conversion circuit 607.

The image processing circuit 106 reads out, from the second memory 105, the pixel values of coordinates on an image before deformation calculated by the calculation circuit 103 that correspond to coordinates on the image after a deformation generated by the output coordinate generation circuit 702, and outputs the pixel values.

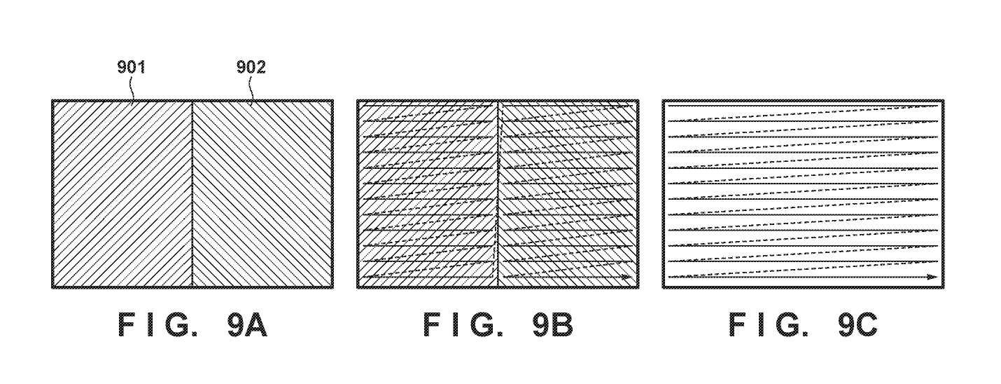

The rectangle size conversion circuit 607 performs rearrangement as shown in FIGS. 9A to 9C based on the above-described information regarding combination of rectangles, and performs conversion such that output images are output in a certain order regardless of the combination of rectangles. FIG. 9A shows an example in which a combination of upper left and lower left regions is selected. As shown in FIG. 9B, an output image of the image processing circuit 106 is output from the top in order in units of such combinations. Therefore, output of the image processing circuit 106 is held in an SRAM or the like based on the information regarding combination of rectangles, and output is performed such that the output image is output in the order shown in FIG. 9C when the right half has been input. In the case of a combination of upper left and upper right regions, in the case where all of the upper left, upper right, lower left, and lower right regions are handled as separate regions, and furthermore, also in the case of a combination of the upper left, upper right, lower left, and lower right region, similarly, rearrangement is performed so as to achieve the output order shown in FIG. 9C, and output is performed.

As described above, according to this embodiment, similar to the first embodiment, the sizes of all of the rectangular regions on an image after deformation do not need to be reduced in accordance with only a few worst cases.

Note that a configuration may be adopted in which it is determined in advance whether or not to divide the regions of an image before deformation, and information indicating whether or not division is required is stored in advance according to the positions of the regions of the image before deformation. Note that the position of a region required to be divided differs according to various factors such as the position of a lens and camera shake information. It is not realistic to store all the possible pieces of information indicating the relationship between the positions of the regions of an image and whether or not division is required, the information differing according to these various factors. In view of this, a configuration may be adopted in which pieces of information indicating the relationship between the positions of the regions of an image and whether or not division is required, which are under a plurality of representative conditions and are associated with each other, are stored in advance, and a type of information is selected when performing image deformation. Note that a configuration is adopted in which information indicating the relationship between the positions of regions of an image and whether or not division is required is selected so as to reliably ensure that the capacity of the second memory 105 is not exceeded, when selecting information.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-151759, filed Aug. 4, 2017 which is hereby incorporated by reference herein in its entirety.

What is claimed is:

1. An image processing apparatus that applies geometric deformation to an input image, comprising:
at least one non-transitory memory device;
at least one processor;
a first memory configured to store the input image as an image before geometric deformation;
a calculation unit configured to calculate coordinates of a region of the image before geometric deformation that corresponds to a region included in the image after geometric deformation;
a readout unit configured to read out, from the first memory, a rectangular region that encompasses the region of the image before geometric deformation calculated by the calculation unit;
a second memory configured to store the rectangular region read out by the readout unit; and
an image processing unit configured to read out the image before geometric deformation from the second memory, and generate the image after geometric deformation,
wherein, at a first position of the image after geometric deformation, the readout unit reads out a third rectangular region that encompasses a region of the image before geometric deformation that corresponds to a first rectangular region corresponding to the first position from among a plurality of first rectangular regions obtained by dividing the image after geometric deformation, based on coordinates of the region of the image before geometric deformation that corresponds to the first rectangular region, and, at a second position of the image after geometric deformation, reads out a fourth rectangular region that encompasses a region of the image before geometric deformation that corresponds to a second rectangular region corresponding to the second position from among a plurality of second rectangular regions obtained by dividing the first rectangular regions, based on coordinates of the region of the image before geometric deformation that corresponds to the second rectangular region, and
wherein the calculation unit, the readout unit, and the image processing unit are implemented by the at least one processor executing at least one program recorded on the at least one non-transitory memory device.

2. The image processing apparatus according to claim 1,
wherein the readout unit reads out the fourth rectangular region at a position in the image after geometric deformation at which a size of a region that encompasses the region of the image before geometric deformation that corresponds to the first rectangular region exceeds a capacity of the second memory.

3. The image processing apparatus according to claim 1,
wherein the second rectangular region is one of rectangular regions acquired by vertically dividing the first rectangular regions into two.

4. The image processing apparatus according to claim 1,
wherein the second rectangular region is one of rectangular regions acquired by vertically and horizontally dividing the first rectangular regions into four.

5. The image processing apparatus according to claim 1,
wherein the capacity of the second memory is a capacity that is set such that data of the first rectangular region fits in.

6. The image processing apparatus according to claim 1,
wherein the input image is an image in which a size of the third rectangular region in the image before geometric deformation that corresponds to the first rectangular region in the image after geometric deformation differs depending on coordinates in the image, and the capacity of the second memory is a capacity that is set such that data of the third rectangular region that is smallest in the image before geometric deformation fits in.

7. The image processing apparatus according to claim 1,
wherein the input image is an image that includes distortion aberration of an imaging lens, a size of the third rectangular region in a peripheral portion of the image before geometric deformation is larger than a size of the third rectangular region in a central portion of the image before geometric deformation, and the capacity of the second memory is set such that the data of the third rectangular region in the central portion of the image before geometric deformation fits in.

8. The image processing apparatus according to claim 1, further comprising:
a conversion unit configured to convert an order in an image after geometric deformation in a case where the fourth rectangular region is stored in the second memory,
wherein the conversion unit is implemented by the at least one processor executing at least one program recorded on the at least one non-transitory memory.

9. An image processing method for applying geometric deformation to an input image, the method comprising:
storing the input image as an image before geometric deformation to a first memory;
calculating coordinates of a region of the image before geometric deformation that corresponds to a region included in the image after geometric deformation;
reading out, from the first memory, a rectangular region that encompasses the region of the image before geometric deformation calculated in the calculation;
storing the rectangular region read out in the reading out, to a second memory; and
reading out the image before geometric deformation from the second memory and generating the image after geometric deformation,
wherein, in the reading out, at a first position of the image after geometric deformation, a third rectangular region that encompasses a region of the image before geometric deformation that corresponds to a first rectangular region corresponding to the first position from among a plurality of first rectangular regions obtained by dividing the image after geometric deformation is read out based on coordinates of the region of the image before geometric deformation that corresponds to the first rectangular region, and, at a second position of the image after geometric deformation, a fourth rectangular region that encompasses a region of the image before geometric deformation that corresponds to a second rectangular region corresponding to the second position from among a plurality of second rectangular regions obtained by dividing the first rectangular regions is read out based on coordinates of the region of the image before geometric deformation that corresponds to the second rectangular region.

10. A computer-readable storage medium that stores a program for causing a computer to execute steps of an image processing method for applying geometric deformation to an input image, the method comprising:
storing the input image as an image before geometric deformation to a first memory,
calculating coordinates of a region of the image before geometric deformation that corresponds to a region included in the image after geometric deformation;
reading out, from the first memory, a rectangular region that encompasses the region (of the image) before geometric deformation calculated in the calculation;
storing the rectangular region read out in the reading out, to a second memory; and
reading out the image before geometric deformation from the second memory and generating the image after geometric deformation,
wherein, in the reading out, at a first position of the image after geometric deformation, a third rectangular region that encompasses a region of the image before geometric deformation that corresponds to a first rectangular region corresponding to the first position from among a plurality of first rectangular regions obtained by dividing the image after geometric deformation is read out based on coordinates of the region of the image before geometric deformation that corresponds to the first rectangular region, and, at a second position of the image after geometric deformation, a fourth rectangular region that encompasses a region of the image before geometric deformation that corresponds to a second rectangular region corresponding to the second position from among a plurality of second rectangular regions obtained by dividing the first rectangular regions is read out based on coordinates of the region of the image before geometric deformation that corresponds to the second rectangular region.
